(19) United States
(12) Patent Application Publication
(10) Pub. No.: US 2024/0070089 A1
(43) Pub. Date: Feb. 29, 2024

(54) MEASUREMENT COMMAND FOR MEMORY SYSTEMS

(71) Applicant: Micron Technology, Inc., Boise, ID (US)

(72) Inventor: Lance W. Dover, Fair Oaks, CA (US)

(21) Appl. No.: 18/351,986

(22) Filed: Jul. 13, 2023

Related U.S. Application Data
(60) Provisional application No. 63/374,018, filed on Aug. 31, 2022.

(51) Int. Cl. G06F 12/14; H04L 9/32

(52) U.S. Cl. CPC G06F 12/1408; H04L 9/3242; G06F 2212/1052

(57) ABSTRACT

Methods, systems, and devices for a measurement command for memory systems are described. A memory system and a host system may support a measure command to calculate a cryptographic value of data stored in a region of the memory system. In some cases, a region indicated by the measure command may correspond to a protected region of the memory system. In such cases, the measure command may include a cryptographic signature from the host system. Upon receiving the measure command, the memory system may perform a hashing operation on the data to generate the cryptographic value. In some cases, the memory system may transmit the digest to the host. Additionally or alternatively, the memory system may extend the digest into a register indicated by the command. Further, the measure command may be used to generate a key pair associated with the memory system.

### CROSS REFERENCE

The present application for patent claims priority to U.S. Provisional Patent Application No. 63/374,018 by Dover, entitled “MEASUREMENT COMMAND FOR MEMORY SYSTEMS” and filed Aug. 18, 2022, which is assigned to the assignee hereof and is expressly incorporated by reference herein.

### FIELD OF TECHNOLOGY

The following relates to one or more systems for memory, including a measurement command for memory systems.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read (e.g., sense, detect, retrieve, identify, determine, evaluate) the state of one or more memory cells within the memory device. To store information, a component may write (e.g., program, set, assign) one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be described in terms of volatile configurations or non-volatile configurations. Volatile memory cells (e.g., DRAM) may lose their programmed states over time unless they are periodically refreshed by an external power source. Non-volatile memory cells (e.g., NAND) may maintain their programmed states for extended periods of time even in the absence of an external power source.

### BRIEF DESCRIPTION OF THE DRAWINGS

FIG. 1 illustrates an example of a system that supports a measurement command for memory systems in accordance with examples as disclosed herein.

FIG. 2 illustrates an example of a system that supports a measurement command for memory systems in accordance with examples as disclosed herein.

FIG. 3 illustrates an example of a process flow that supports a measurement command for memory systems in accordance with examples as disclosed herein.

FIG. 4 shows a block diagram of a memory system that supports a measurement command for memory systems in accordance with examples as disclosed herein.

FIGS. 5 and 6 show flowcharts illustrating a method or methods that support a measurement command for memory systems in accordance with examples as disclosed herein.

### DETAILED DESCRIPTION

In some examples, a memory system and a host system may form a computing system which supports a measure command to calculate a cryptographic value of data stored in a region of the memory system indicated by the measure command. In some cases, the region indicated by the measure command may correspond to a protected region of the memory system. In such cases, the measure command may include a cryptographic signature from the host system, and the memory system may authenticate the signature to determine whether the host system is authorized to access the protected region. Upon receiving the measure command, the memory system may perform a hashing operation on the data to generate an output, which may correspond to the cryptographic value. In some cases, the memory system may transmit the digest to the host system (e.g., as a response to the command).

Additionally or alternatively, the memory system may extend the digest into a register indicated by the command. For example, the memory system may combine the digest with a value previously stored in the register, such as by performing a hashing operation on the digest and the previously stored value, and the memory system may store the resulting value in the register. Or, as another example, the measure command may be used to generate a key pair (e.g., an asymmetric key pair) associated with the memory system. For example, the digest may be incorporated with additional factors of the memory system (e.g., hardware factors, software factors) to create a device identifier for the memory system. The device identifier may correspond to a private key of the key pair, and a public may be generated using a key generation procedure using the private key.

The measure command and associated techniques described herein may allow the memory system and the host system to perform multiple cryptographic functions using a single measure command (e.g., generating a digest, extending a register, generating a key pair, or any combination thereof), which may reduce signaling overhead associated with transmitting and performing multiple commands. Accordingly, system performance may be improved, for example by reducing bandwidth, reducing volatile storage space associated with storing and processing commands, and increasing system security, among other benefits.

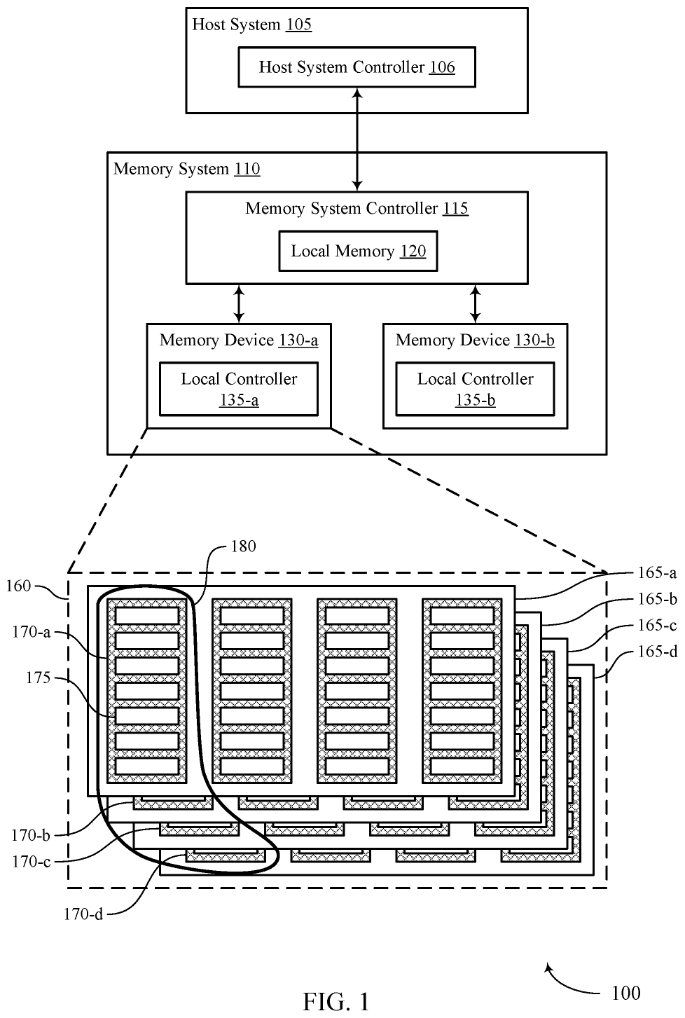

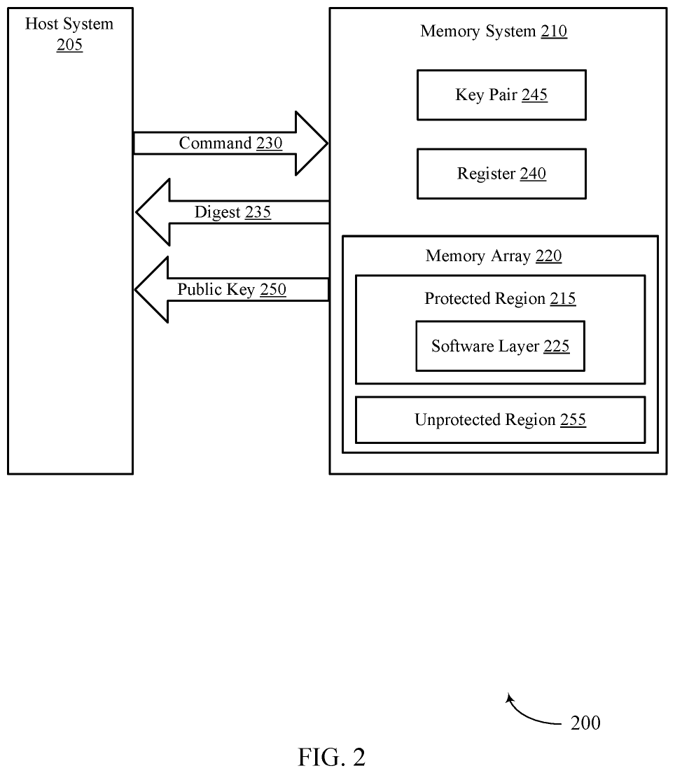

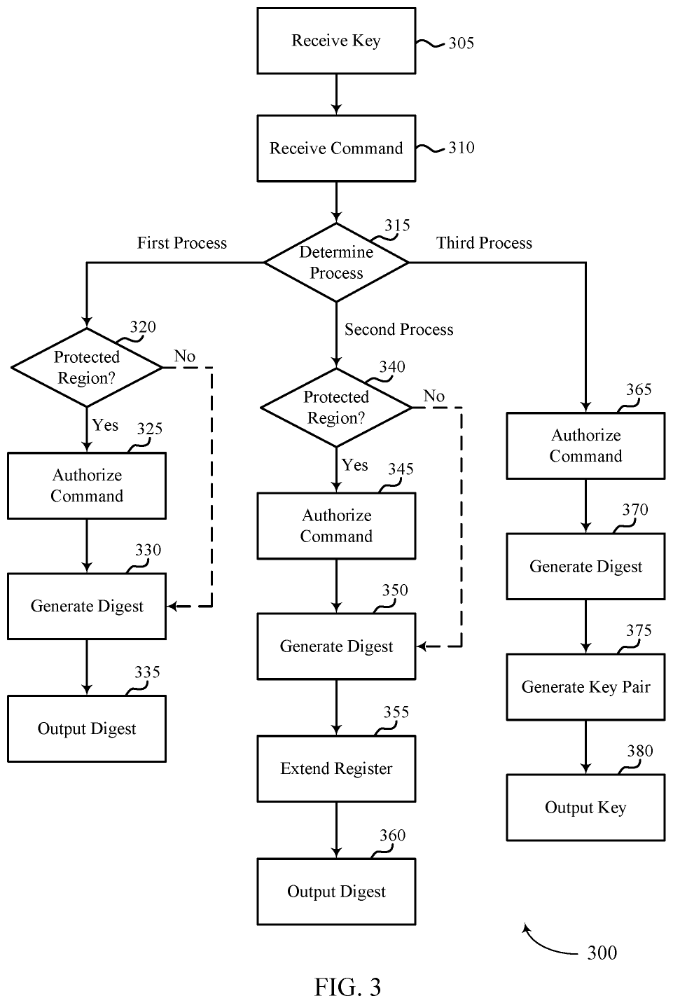

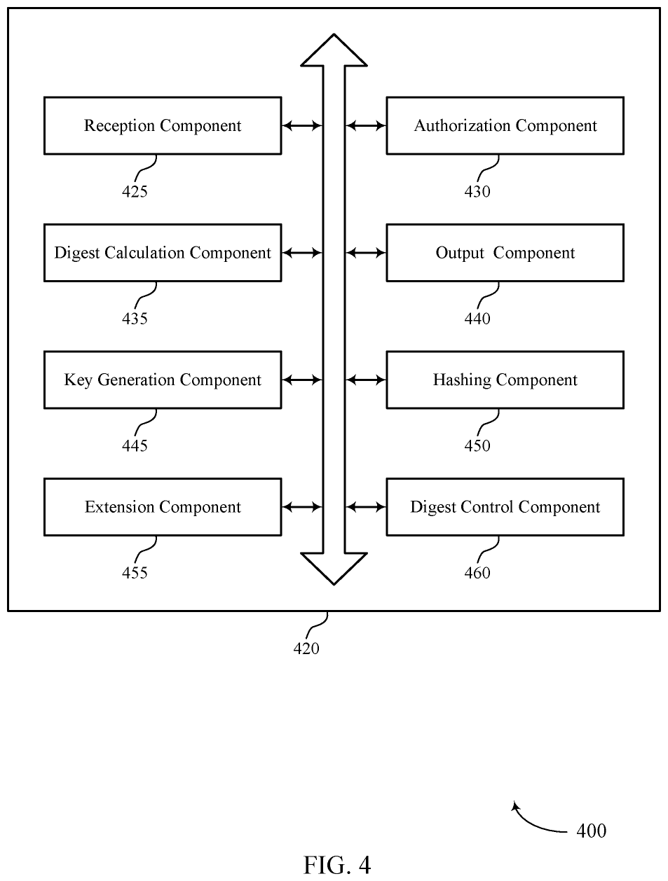

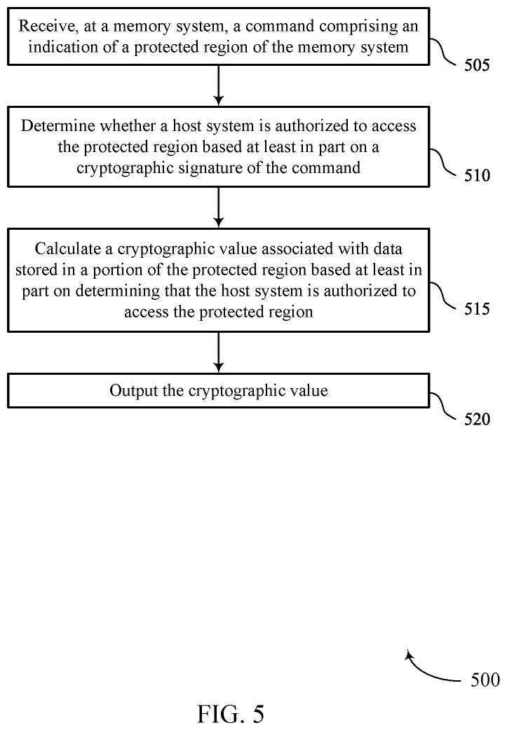

Features of the disclosure are initially described in the context of systems, devices, and circuits with reference to FIG. 1. Features of the disclosure are described in the context of a system and a process flow with reference to FIGS. 2 through 3. These and other features of the disclosure are further illustrated by and described in the context of an apparatus diagram and flowchart that relate to a measurement command for memory systems with reference to FIGS. 4 through 5.

FIG. 1 illustrates an example of a system 100 that supports a measurement command for memory systems in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide-based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

The system 100 may include any quantity of non-transitory computer readable media that support a measurement command for memory systems. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some examples, a memory system 110 and a host system 105 may form a computing system which supports a measure command to calculate a cryptographic value of data stored in a region of the memory system 110 (e.g., a region of a memory device 130) indicated by the measure command. As used herein, a cryptographic value may refer to an output of a cryptographic hashing function. The result of applying a cryptographic hashing function to a set of information may be referred to as a cryptographic value of or for the set of information. In some cases, the region indicated by the measure command may correspond to a protected region of the memory system 110. In such cases, the measure command may include a cryptographic signature from the host system 105, and the memory system 110 may authenticate the signature to determine whether the host system 105 is authorized to access the protected region. Upon receiving the measure command, the memory system 110 may perform a hashing operation on the data to generate an output, which may correspond to the cryptographic value. In some cases, the memory system 110 may transmit the digest to the host system 105 (e.g., as a response to the command). Additionally or alternatively, the memory system 110 may extend the digest into a register indicated by the command. For example, the memory system 110 may combine the digest with a value previously stored in the register, such as by performing a hashing operation on the digest and the previously stored value, and the memory system 110 may store the resulting value in the register. Further, the measure command may be used to generate a key pair (e.g., an asymmetric key pair) associated with the memory system 110. For example, the digest may be incorporated with additional factors of the memory system 110 (e.g., hardware factors, software factors) to create a device identifier for the memory system 110. The device identifier may correspond to a private key of the key pair, and a public may be generated using a key generation procedure using the private key.

FIG. 2 illustrates an example of a system 200 that supports a measurement command for memory systems in accordance with examples as disclosed herein. The system 200 may include aspects of the system 100. For example, the system 200 may include a memory system 210 and a host system 205, which may be examples of the memory system 110 and the host system 105 as described with reference to FIG. 2. The memory system 210 may be integrated with or in communication with the host system 105 to form a computing system.

The memory system 210 may include one or more protected regions 215 of a memory array 220. The protected region 215 may be an example of a replay protected memory block (RPMB), and as such may act as a secure location to store sensitive data, such as one or more software layers 225 used to initialize or operate the computing system.

For example, the protected region 215 may store code or other information related to a software layer 225 used to initialize or operate the computing system. In some cases, the software layer 225 may be an example of initialization instructions for the computing system (e.g., boot code, L0 code). Additionally or alternatively, the software layer 225 may be an example of an operating system for the computing system (e.g., an operation system kernel, L1 code).

The host system 205 and memory system 210 may support a command 230 (e.g., a measure command) to generate a cryptographic value of data stored in a region of the memory system 210 (e.g., a region of the memory array 220). The cryptographic value may correspond to or may be an example of an output of a hashing operation performed on the data stored in the region (e.g., the cryptographic value may be an example of a digest). For example, the data stored in the region a may act as an input to the hashing operation, and the hashing operation may map the input to a fixed size output (e.g., an output having a size determined by the type of hashing operation used).

Additionally or alternatively, the cryptographic value may be an example of a message authentication code (MAC) value. For example, the hashing operation used to generate the cryptographic value may incorporate a key (e.g., a key pair shared between the host system 205 and the memory system 210, a secret key) to calculate the cryptographic value. In some cases, the MAC value may be an example of a hash-based MAC (HMAC) (e.g., using a secret key), a cipher-based MAC (CMAC), or another type of MAC.

In some examples, the host system 205 may transmit the command 230 to the memory system 210 to generate a cryptographic value of a region of the memory system 210. The command 230 may include an indication of the region, such as by including a range of addresses (e.g., logical addresses) on which to perform the hashing operation, or a starting address and ending address of the region. In some examples, the command 230 may include an indication of multiple regions and may indicate to perform a hashing operation using each of the regions as inputs to generate a single digest. Additionally or alternatively, the command 230 may indicate to perform a set of hashing operations using respective subsets of the multiple regions as inputs to generate a corresponding set of digests. Further, the command 230 may include an indication a type of hashing function to use in generating a digest (e.g., secure hashing function (SHA)-256, SHA-384, SHA-512, among other examples).

In some cases, the region indicated by the command 230 may correspond to a range of data stored within the protected region 215. The command 230 may indicate one or more ranges of addresses corresponding to a subset of the protected region 215, or the command 230 may indicate a range of addresses corresponding to the protected region 215. In such cases, the host system 205 may include a cryptographic signature in the command 230, which may indicate to the memory system 210 that the host system 205 is authorized to access the protected region 215. The host system 205 may generate the signature using a key or key pair associated with the host system 205 and the memory system 210 (e.g., a previously exchanged shared key or asymmetric key pair). Additionally or alternatively, the signature may be generated and added to the command 230 by a device owner (e.g., an owner of the memory system 210, the host system 205, or both). For example, a device owner may be authorized to access all or some of multiple protected regions of the memory system 210. Accordingly, the device owner may authorize the command 230 by generating and adding a signature associated with the device owner to the command 230. In some cases, a device owner may be authorized to access each region of the memory system 210. For example, the memory system 210 or an entire device therein may be an example of a single protected region, and a device owner may be authorized to access any region of the memory system (e.g., using a corresponding signature). Thus, techniques described herein as applied to a protected region 215 may alternatively be applied on a device-wide or system-wide basis.

Upon receiving the command 230, the memory system 210 may attempt to decrypt the signature to determine whether the host system 205 is authorized to access the protected region 215. For example, the memory system may decrypt or otherwise translate the signature using a key (e.g., a shared key, an asymmetric key pair) associated with the host system 205. If the memory system 210 successfully decrypts the signature, the memory system 210 may determine that the host system 205 is authorized to access the protected region 215, and the memory system 210 may accordingly perform the hashing operation on the one or more ranges of addresses of the protected region 215 to generate a digest 235. Additionally or alternatively, if the memory system 210 does not successfully decrypt the signature, the memory system 210 may determine that the host system 205 is not authorized to access the protected region 215. In such cases, the memory system 210 may transmit an indication to the host system 205 that the host system 205 may not be authorized to access the protected region 215.

Additionally or alternatively, the command 230 may include an indication to generate a digest of data stored in an unprotected region 255 of the memory system 210. In such cases, the host system 205 may not include a signature in the command 230, and the memory system 210 may generate the digest without attempting to decrypt a signature of the command 230, which may reduce latency associated with a command 230 for an unprotected region 255.

In some examples, the command 230 may include a request for the digest 235. Accordingly, upon generating the digest 235, the memory system 210 may transmit the digest 235 to the host system 205 (e.g., as a response to the command 230). Additionally or alternatively, the command 230 may include an indication to store a value corresponding to the digest 235 in a register 240 of the memory system 210. For example, the command 230 may include an address of the register 240. In such cases, upon generating the digest 235, the memory system 210 may store the value in the register 240, for example by extending the digest 235 into the register 240.

To extend the digest 235 into the register 240, the memory system 210 may calculate a second digest using the digest 235, as well as a value previously stored in the register 240, as inputs to an additional hashing operation. The output of the additional hashing operation may be stored in the register 240. In some cases, the register 240 may be an example of a register dedicated to storing a digest, such as a platform configuration register (PCR).

In some cases, the command 230 may include an indication to use the digest 235, or the digest generated by extending the digest 235 into the register 240, to generate one or more key pairs 245, such as a first asymmetric key pair (e.g., a DeviceID (DID) asymmetric key pair), a second asymmetric key pair (e.g., an Alias asymmetric key pair), or both. For example, the digest may be used to generate a private key of the key pair 245, and the memory system 210 may generate the public key 250 of the key pair 245 using a key generation algorithm (e.g., elliptic curve cryptography). In such cases, the memory system 210 may output the public key 250 to the host system 205. Additionally, although the command 230 may indicate a protected region 215 of the memory system 210, because such a command 230 may be issued at an early stage of an initialization procedure, the command 230 may not include a signature, and the memory system 210 may not attempt to decrypt a signature prior to generating the digest and key pair 245.

FIG. 3 illustrates an example of a process flow 300 that supports a measurement command for memory systems in accordance with examples as disclosed herein. The process flow 300 may include aspects of the system 100 and of the system 200. For example, the process flow 300 may include receiving a command (e.g., a command 230) to generate, and in some cases output, a digest (e.g., a digest 235), as described with reference to FIG. 2. The process flow 300 may be performed by a computing system, which may include a host system (e.g., a host system 105, a host system 205) and a memory system (e.g., a memory system 110, a memory system 210).

At 305, a key associated with the host system may be received. For example, the host system and the memory system may exchange one or more keys (e.g., public keys of respective asymmetric key pairs, shared keys), which may allow the memory system to verify the identity of the host system. The key associated with the host system may also be associated with a protected region of the memory system. For example, the memory system may use the key to verify whether the host system is authorized to access the protected region. In some cases, the memory system may use the key to decrypt or otherwise translate a cryptographic signature from the host system.

At 310, a command may be received. For example, the memory system may receive a command from the host system, which may include an indication of a protected region of the memory system. In some cases, the indication of the protected region may include an indication of a one or more address ranges, which may be discontinuous, within the protected region. Additionally or alternatively, the command may include an indication of an unprotected region of the memory system. In some cases, the command may include an indication to access data in the protected region, generate a digest (e.g., a cryptographic value), extend a register, generate a key pair, output the digest, output a key of the key pair, or any combination thereof. In some cases, the command may include an indication of an operation (e.g., a hashing function) that the memory system may use to calculate the digest. In some cases, the memory system may receive the command subsequent to receiving the key associated with the host system.

At 315, one of three processes may be determined according to the command. For example, the memory system may determine which of three processes to use using one or more factors included in the command. For example, upon receiving a command which includes an indication to extend a register, the memory system may determine to use the second process (e.g., the process flow may proceed to 340). In other examples, upon receiving a command which includes an indication to generate a key pair, the memory system may determine to use the third process (e.g., the process flow may proceed to 365).

In some cases, if the memory system receives a command including an indication to generate and output a digest, but the memory system does not receive an indication to extend a register, the memory system may determine to use the first process at 315. In some cases, the command may include an indication of a region of the memory system. The region may be a protected region or an unprotected region. For example, the command may include a request to access the indicated region.

At 320, it may be determined whether the command includes an indication to access a protected region. For example, the memory system may determine whether the range of addresses include addresses within a protected region. If the command does not include an indication to access a protected region (e.g., if the range of addresses are each within an unprotected region of the memory system), the memory system may suppress authorizing the command, and the process flow may proceed to 330. Additionally or alternatively, if the memory system determines that the command includes an indication to access a protected region, the memory system may attempt to authorize the command.

At 325, the command may be authorized (e.g., authenticated or verified). For example, the memory system may attempt to decrypt a cryptographic signature included in the command (e.g., using the key received at 305). If the memory system successfully decrypts the signature, the memory system may determine that the host system is authorized to access the protected region, and the process flow may proceed to 330. Additionally or alternatively, if the memory system does not successfully decrypt the command, the memory system may determine that the host system is not authorized to access the protected region. In such cases, the memory system may transmit an indication to the host system that the host system is not authorized to access the protected region.

At 330, a cryptographic value may be generated. For example, the memory system may generate the cryptographic value in response to the command. In some cases, the memory system may calculate the cryptographic value, according to an indication included in the command, by performing a function (e.g., a hashing function) on data stored region indicated in the command. For example, the cryptographic value may correspond to or may derive from the output of the function.

At 335, the cryptographic value may be output. For example, the memory system may output the cryptographic value to the host system (e.g., using a network implemented by a computing system).

In some cases, if the memory system receives a command including an indication to generate a digest, extend a register to store the digest, and output the digest, the memory system may determine to use the second process at 315. In some cases, the command may include an indication of a region of the memory system. The region may be a protected region or an unprotected region. For example, the command may include a request to access the indicated region.

At 340, it may be determined whether the command includes an indication to access a protected region. For example, the memory system may determine whether the range of addresses include addresses within a protected region. If the command does not include an indication to access a protected region (e.g., if the range of addresses are each within an unprotected region of the memory system), the memory system may suppress authorizing the command, and the process flow may proceed to 350. Additionally or alternatively, if the memory system determines that the command includes an indication to access a protected region, the memory system may attempt to authorize the command.

At 345, the command may be authorized (e.g., authenticated or verified). For example, the memory system may attempt to decrypt a cryptographic signature included in the command (e.g., using the key received at 305). If the memory system successfully decrypts the signature, the memory system may determine that the host system is authorized to access the protected region, and the process flow may proceed to 350. Additionally or alternatively, if the memory system does not successfully decrypt the command, the memory system may determine that the host system is not authorized to access the protected region. In such cases, the memory system may transmit an indication to the host system that the host system is not authorized to access the protected region.

At 350, a cryptographic value may be generated. For example, the memory system may generate the cryptographic value in response to the command. In some cases, the memory system may calculate the cryptographic value, according to an indication included in the command, by performing a function (e.g., a hashing function) on data stored region indicated in the command. For example, the cryptographic value may correspond to or may derive from the output of the function.

At 355, a register may be extended to store a second cryptographic value in a register. For example, the command may include an address of a register, and the memory system may extend the register to store the second cryptographic value in the register. In some cases, the register may be a PCR. In some cases, the register may contain data, such as a previously stored cryptographic value. The command may include an indication to store a second cryptographic value in the register and an indication of an address of the register. In some cases, a cryptographic value may be transmitted (e.g., output to the host system) upon extending the register. For example, extending the register may include performing a hashing function on the previously stored cryptographic value and the digest generated at 350. The output of the hashing function may correspond to the second cryptographic value, and the output of the hashing function may be stored in the register.

At 360, the cryptographic value may be output. For example, the memory system may output the cryptographic value to the host system (e.g., using a network implemented by a computing system).

In some cases, if the memory system receives a command including an indication to generate a key pair and output at least one key of the key pair, the memory system may determine to use the third process at 315. In some cases, the command may include an indication of a region of the memory system. The region may be a protected region or an unprotected region. For example, the command may include a request to access the indicated region. In some examples, the indicated region may include a software layer of the memory device, such as initialization instructions for the computing system (e.g., L0 boot code).

In some cases, at 365, the command may be authorized (e.g., authenticated or verified). For example, the memory system may attempt to decrypt a cryptographic signature included in the command (e.g., using the key received at 305). If the memory system successfully decrypts the signature, the memory system may determine that the host system is authorized to access the protected region, and the process flow may proceed to 350. Additionally or alternatively, if the memory system does not successfully decrypt the signature, the memory system may determine that the host system is not authorized to access the protected region. In such cases, the memory system may transmit an indication to the host system that the host system is not authorized to access the protected region. In other cases, the memory system may not authorize the command (e.g., the memory system may skip 365 of FIG. 3), regardless of whether the command indicates a protected or an unprotected region. For example, the memory system may receive the command and generate a cryptographic value without attempting to decrypt a signature (e.g., by proceeding to 370).

At 370, a cryptographic value may be generated. For example, the memory system may generate the cryptographic value in response to the command. In some cases, the memory system may calculate the cryptographic value, according to an indication included in the command, by performing a function (e.g., a hashing function) on data stored region indicated in the command. For example, the cryptographic value may correspond to or may derive from the output of the function.

At 375, a key pair may be generated. For example, the memory system may generate the key pair, which may include a public key and a private key, which may each be associated with the memory system. Thus, the key pair may be an asymmetric key pair (e.g., a DID or alias key pair). In some cases, the memory system may generate the key pair using the cryptographic value. For example, the private key of the key pair may derive from software characteristics of the memory system, such as the cryptographic value. Additionally or alternatively, the private key of the key pair may derive from hardware or physical characteristics (e.g., circuit elements) of the memory system. In some cases, the private key of the key pair may correspond to a device identifier, which may include hardware and software factors. The memory system may generate the public key of the key pair using a key generation algorithm (e.g., elliptic curve cryptography).

At 380, the public key of the key pair may be output. For example, the memory system may output the public key of the key pair to the host system (e.g., using a network implemented by a computing system).

Aspects of the process flow 300 may be implemented by a controller, among other components. Additionally or alternatively, aspects of the process flow 300 may be implemented as instructions stored in memory (e.g., firmware stored in a memory coupled with the memory system 210). For example, the instructions, if executed by a controller (e.g., the memory system controller 115), may cause the controller to perform the operations of the process flow 300.

FIG. 4 shows a block diagram 400 of a memory system 420 that supports a measurement command for memory systems in accordance with examples as disclosed herein. The memory system 420 may be an example of aspects of a memory system as described with reference to FIGS. 1 through 3. The memory system 420, or various components thereof, may be an example of means for performing various aspects of a measurement command for memory systems as described herein. For example, the memory system 420 may include a reception component 425, an authorization component 430, a digest calculation component 435, an output component 440, a key generation component 445, a hashing component 450, an extension component 455, a digest control component 460, or any combination thereof. Each of these components may communicate, directly or indirectly, with one another (e.g., via one or more buses).

The reception component 425 may be configured as or otherwise support a means for receiving, at a memory system, a command including an indication of a protected region of the memory system. The authorization component 430 may be configured as or otherwise support a means for determining whether a host system is authorized to access the protected region based at least in part on a cryptographic signature of the command. The digest calculation component 435 may be configured as or otherwise support a means for calculating a cryptographic value associated with data stored in a portion of the protected region based at least in part on determining that the host system is authorized to access the protected region. The output component 440 may be configured as or otherwise support a means for outputting the cryptographic value.

In some examples, to support calculating the cryptographic value, the hashing component 450 may be configured as or otherwise support a means for performing a hashing operation on the data to generate the cryptographic value in response to the command.

In some examples, the hashing component 450 may be configured as or otherwise support a means for performing a hashing operation on the data to generate a second cryptographic value in response to the command. In some examples, the extension component 455 may be configured as or otherwise support a means for extending a register of the memory system to store the second cryptographic value in the register, where the output (e.g., transmitted) cryptographic value is calculated based at least in part on extending the register.

In some examples, to support extending the register, the digest calculation component 435 may be configured as or otherwise support a means for calculating the cryptographic value based at least in part on applying a hashing function to the second cryptographic value and a value stored in the register. In some examples, to support extending the register, the digest control component 460 may be configured as or otherwise support a means for storing the cryptographic value in the register.

In some examples, the command further includes an indication of an address of the register.

In some examples, the register includes a platform configuration register.

In some examples, the reception component 425 may be configured as or otherwise support a means for receiving, at the memory system, a key associated with the host system and the protected region, where receiving the command is based at least in part on receiving the key.

In some examples, to support determining whether the host system is authorized, the authorization component 430 may be configured as or otherwise support a means for attempting to decrypt the cryptographic signature of the command based at least in part on the key, where calculating the cryptographic value is based at least in part on successfully decrypting the cryptographic signature.

In some examples, the reception component 425 may be configured as or otherwise support a means for receiving, at the memory system, a second command including a second indication of a second protected region of the memory system. In some examples, the authorization component 430 may be configured as or otherwise support a means for attempting to decrypt a second cryptographic signature of the second command based at least in part on the key. In some examples, the output component 440 may be configured as or otherwise support a means for outputting an indication that the host system is not authorized to access the second protected region based at least in part on the second command.

In some examples, the reception component 425 may be configured as or otherwise support a means for receiving, at the memory system, a second command including a second indication of an unprotected region of the memory system. In some examples, the digest calculation component 435 may be configured as or otherwise support a means for calculating, based at least in part on determining that the second command is associated with the unprotected region, a second cryptographic value associated with data stored in a portion of the unprotected region without determining whether the host system is authorized to access the protected region. In some examples, the output component 440 may be configured as or otherwise support a means for outputting the second cryptographic value.

In some examples, the command further includes an indication of a hashing function for the memory system to use to calculate the cryptographic value.

In some examples, the indication of the protected region includes an indication of a range of addresses within the protected region.

In some examples, the indication of the protected region includes a plurality of discontinuous address ranges within the protected region.

In some examples, the data stored in the portion of the protected region includes initialization instructions for a computing system including the memory system.

In some examples, the cryptographic value is a cryptographic digest.

In some examples, the cryptographic value is a MAC.

In some examples, the reception component 425 may be configured as or otherwise support a means for receiving, at a memory system, a command including an indication of a region of the memory system. In some examples, the digest calculation component 435 may be configured as or otherwise support a means for generating a cryptographic value associated with data stored in the region based at least in part on receiving the command. The key generation component 445 may be configured as or otherwise support a means for generating a key pair including a private key associated with the memory system and a public key associated with the memory system based at least in part on the cryptographic value. In some examples, the output component 440 may be configured as or otherwise support a means for outputting the public key.

In some examples, the authorization component 430 may be configured as or otherwise support a means for determining whether the host system is authorized to access the region based at least in part on a cryptographic signature of the command, where generating the cryptographic value is based at least in part on determining that the host system is authorized.

In some examples, the region includes a protected region associated with the cryptographic signature of the command.

In some examples, to support generating the key pair, the key generation component 445 may be configured as or otherwise support a means for generating a public key of the key pair based at least in part on a private key of the key pair, where the private key of the key pair corresponds to the cryptographic value.

In some examples, the key pair includes an asymmetric key pair.

In some examples, the cryptographic value is a cryptographic digest.

FIG. 5 shows a flowchart illustrating a method 500 that supports a measurement command for memory systems in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving, at a memory system, a command including an indication of a protected region of the memory system. The operations of 505 may be performed in accordance with examples as disclosed herein. In some examples, aspects of the operations of 505 may be performed by a reception component 425 as described with reference to FIG. 4.

At 510, the method may include determining whether a host system is authorized to access the protected region based at least in part on a cryptographic signature of the command. The operations of 510 may be performed in accordance with examples as disclosed herein. In some examples, aspects of the operations of 510 may be performed by an authorization component 430 as described with reference to FIG. 4.

At 515, the method may include calculating a cryptographic value associated with data stored in a portion of the protected region based at least in part on determining that the host system is authorized to access the protected region. The operations of 515 may be performed in accordance with examples as disclosed herein. In some examples, aspects of the operations of 515 may be performed by a digest calculation component 435 as described with reference to FIG. 4.

At 520, the method may include outputting the cryptographic value. The operations of 520 may be performed in accordance with examples as disclosed herein. In some examples, aspects of the operations of 520 may be performed by an output component 440 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, at a memory system, a command including an indication of a protected region of the memory system; determining whether a host system is authorized to access the protected region based at least in part on a cryptographic signature of the command; calculating a cryptographic value associated with data stored in a portion of the protected region based at least in part on determining that the host system is authorized to access the protected region; and outputting the cryptographic value.

Aspect 2: The method, apparatus, or non-transitory computer-readable medium of aspect 1, where the operations, features, circuitry, logic, means, or instructions, or any combination thereof for calculating the cryptographic value includes operations, features, circuitry, logic, means, or instructions, or any combination thereof for performing a hashing operation on the data to generate the cryptographic value in response to the command.

Aspect 3: The method, apparatus, or non-transitory computer-readable medium of any of aspects 1 through 2, further including operations, features, circuitry, logic, means, or instructions, or any combination thereof for performing a hashing operation on the data to generate a second cryptographic value in response to the command and extending a register of the memory system to store the second cryptographic value in the register, where the output cryptographic value is calculated based at least in part on extending the register.

Aspect 4: The method, apparatus, or non-transitory computer-readable medium of aspect 3, where the operations, features, circuitry, logic, means, or instructions, or any combination thereof for extending the register includes operations, features, circuitry, logic, means, or instructions, or any combination thereof for calculating the cryptographic value based at least in part on applying a hashing function to the second cryptographic value and a value stored in the register; and storing the cryptographic value in the register.

Aspect 5: The method, apparatus, or non-transitory computer-readable medium of any of aspects 3 through 4, where the command further includes an indication of an address of the register.

Aspect 6: The method, apparatus, or non-transitory computer-readable medium of any of aspects 3 through 5, where the register includes a platform configuration register.

Aspect 7: The method, apparatus, or non-transitory computer-readable medium of any of aspects 1 through 6, further including operations, features, circuitry, logic, means, or instructions, or any combination thereof for receiving, at the memory system, a key associated with the host system and the protected region, where receiving the command is based at least in part on receiving the key.

Aspect 8: The method, apparatus, or non-transitory computer-readable medium of aspect 7, where the operations, features, circuitry, logic, means, or instructions, or any combination thereof for determining whether the host system is authorized includes operations, features, circuitry, logic, means, or instructions, or any combination thereof for attempting to decrypt the cryptographic signature of the command based at least in part on the key, where calculating the cryptographic value is based at least in part on successfully decrypting the cryptographic signature.

Aspect 9: The method, apparatus, or non-transitory computer-readable medium of aspect 8, further including operations, features, circuitry, logic, means, or instructions, or any combination thereof for receiving, at the memory system, a second command including a second indication of a second protected region of the memory system; attempting to decrypt a second cryptographic signature of the second command based at least in part on the key; and outputting an indication that the host system is not authorized to access the second protected region based at least in part on the second command.

Aspect 10: The method, apparatus, or non-transitory computer-readable medium of any of aspects 1 through 9, further including operations, features, circuitry, logic, means, or instructions, or any combination thereof for receiving, at the memory system, a second command including a second indication of an unprotected region of the memory system; calculating, based at least in part on determining that the second command is associated with the unprotected region, a second cryptographic value associated with data stored in a portion of the unprotected region without determining whether the host system is authorized to access the protected region; and outputting the second cryptographic value.

Aspect 11: The method, apparatus, or non-transitory computer-readable medium of any of aspects 1 through 10, where the command further includes an indication of a hashing function for the memory system to use to calculate the cryptographic value.

Aspect 12: The method, apparatus, or non-transitory computer-readable medium of any of aspects 1 through 11, where the indication of the protected region includes an indication of a range of addresses within the protected region.

Aspect 13: The method, apparatus, or non-transitory computer-readable medium of any of aspects 1 through 12, where the indication of the protected region includes a plurality of discontinuous address ranges within the protected region.

Aspect 14: The method, apparatus, or non-transitory computer-readable medium of any of aspects 1 through 13, where the data stored in the portion of the protected region includes initialization instructions for a computing system including the memory system.

Aspect 15: The method, apparatus, or non-transitory computer-readable medium of any of aspects 1 through 14, where cryptographic value is a cryptographic digest.

Aspect 16: The method, apparatus, or non-transitory computer-readable medium of any of aspects 1 through 15, where cryptographic value is a MAC.

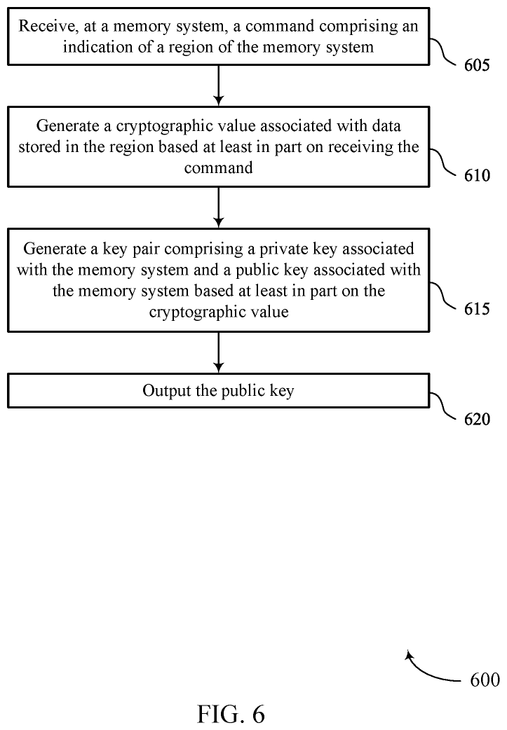

FIG. 6 shows a flowchart illustrating a method 600 that supports a measurement command for memory systems in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include receiving, at a memory system, a command including an indication of a region of the memory system. The operations of 605 may be performed in accordance with examples as disclosed herein. In some examples, aspects of the operations of 605 may be performed by a reception component 425 as described with reference to FIG. 4.

At 610, the method may include generating a cryptographic value associated with data stored in the region based at least in part on receiving the command. The operations of 610 may be performed in accordance with examples as disclosed herein. In some examples, aspects of the operations of 610 may be performed by a digest calculation component 435 as described with reference to FIG. 4.

At 615, the method may include generating a key pair including a private key associated with the memory system and a public key associated with the memory system based at least in part on the cryptographic value. The operations of 615 may be performed in accordance with examples as disclosed herein. In some examples, aspects of the operations of 615 may be performed by a key generation component 445 as described with reference to FIG. 4.

At 620, the method may include outputting the public key. The operations of 620 may be performed in accordance with examples as disclosed herein. In some examples, aspects of the operations of 620 may be performed by an output component 440 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 17: A method, apparatus, or non-transitory computer-readable medium including operations, features, circuitry, logic, means, or instructions, or any combination thereof for receiving, at a memory system, a command including an indication of a region of the memory system; generating a cryptographic value associated with data stored in the region based at least in part on receiving the command; generating a key pair including a private key associated with the memory system and a public key associated with the memory system based at least in part on the cryptographic value; and outputting the public key.

Aspect 18: The method, apparatus, or non-transitory computer-readable medium of aspect 17, further including operations, features, circuitry, logic, means, or instructions, or any combination thereof for determining whether the host system is authorized to access the region based at least in part on a cryptographic signature of the command, where generating the cryptographic value is based at least in part on determining that the host system is authorized.

Aspect 19: The method, apparatus, or non-transitory computer-readable medium of aspect 18, where the region includes a protected region associated with the cryptographic signature of the command.

Aspect 20: The method, apparatus, or non-transitory computer-readable medium of any of aspects 17 through 19, where the operations, features, circuitry, logic, means, or instructions, or any combination thereof for generating the key pair includes operations, features, circuitry, logic, means, or instructions, or any combination thereof for generating a public key of the key pair based at least in part on a private key of the key pair, where the private key of the key pair corresponds to the cryptographic value.

Aspect 21: The method, apparatus, or non-transitory computer-readable medium of any of aspects 17 through 20, where the key pair includes an asymmetric key pair.

Aspect 22: The method, apparatus, or non-transitory computer-readable medium of any of aspects 17 through 21, where the cryptographic value comprises a cryptographic digest.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily doped, e.g., degenerate, semiconductor region. The source and drain may be separated by a lightly doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a memory system; and
a controller associated for the memory system, wherein the controller is configured to cause the apparatus to:
receive, at the memory system, a command comprising an indication of a protected region of the memory system;
determine whether a host system is authorized to access the protected region based at least in part on a cryptographic signature of the command;
calculate a cryptographic value associated with data stored in a portion of the protected region based at least in part on determining that the host system is authorized to access the protected region; and
output the cryptographic value.

2. The apparatus of claim 1, wherein, to calculate the cryptographic value, the controller is configured to cause the apparatus to:
perform a hashing operation on the data to generate the cryptographic value in response to the command.

3. The apparatus of claim 1, wherein the controller is further configured to cause the apparatus to:
perform a hashing operation on the data to generate a second cryptographic value in response to the command; and
extend a register of the memory system to store the second cryptographic value in the register, wherein the controller is configured to cause the apparatus to calculate the output cryptographic value based at least in part on extending the register.

4. The apparatus of claim 3, wherein, to extend the register, the controller is configured to cause the apparatus to:
calculate the cryptographic value based at least in part on applying a hashing function to the second cryptographic value and a value stored in the register; and
store the cryptographic value in the register.

5. The apparatus of claim 3, wherein the command further comprises an indication of an address of the register.

6. The apparatus of claim 3, wherein the register comprises a platform configuration register.

7. The apparatus of claim 1, wherein the controller is further configured to cause the apparatus to:
receive, at the memory system, a key associated with the host system and the protected region, wherein the controller is configured to cause the apparatus to receive the command based at least in part on receiving the key.

8. The apparatus of claim 7, wherein, to determine whether the host system is authorized, the controller is configured to cause the apparatus to:
attempt to decrypt the cryptographic signature of the command based at least in part on the key, wherein the controller is configured to cause the apparatus to calculate the cryptographic value based at least in part on successfully decrypting the cryptographic signature.

9. The apparatus of claim 8, wherein the controller is further configured to cause the apparatus to:
receive, at the memory system, a second command comprising a second indication of a second protected region of the memory system;
attempt to decrypt a second cryptographic signature of the second command based at least in part on the key; and
output an indication that the host system is not authorized to access the second protected region based at least in part on the second command.

10. The apparatus of claim 1, wherein the controller is further configured to cause the apparatus to:
receive, at the memory system, a second command comprising a second indication of an unprotected region of the memory system;
calculate, based at least in part on determining that the second command is associated with the unprotected region, a second cryptographic value associated with data stored in a portion of the unprotected region without determining whether the host system is authorized to access the protected region; and
output the second cryptographic value.

11. The apparatus of claim 1, wherein the command further comprises an indication of a hashing function for the memory system to use to calculate the cryptographic value.

12. The apparatus of claim 1, wherein the indication of the protected region comprises an indication of a range of addresses within the protected region.

13. The apparatus of claim 1, wherein the indication of the protected region comprises a plurality of discontinuous address ranges within the protected region.

14. The apparatus of claim 1, wherein the data stored in the portion of the protected region comprises initialization instructions for a computing system comprising the memory system.

15. An apparatus, comprising:
a memory system; and
a controller for the memory system, wherein the controller is configured to cause the apparatus to:
receive, at a memory system, a command comprising an indication of a region of the memory system;
generate a cryptographic value associated with data stored in the region based at least in part on receiving the command;
generate a key pair comprising a private key associated with the memory system and a public key associated with the memory system based at least in part on the cryptographic value; and
output the public key.

16. The apparatus of claim 15, wherein the controller is further configured to cause the apparatus to:
determine whether a host system is authorized to access the region based at least in part on a cryptographic signature of the command, wherein the controller is configured to cause the apparatus to generate the cryptographic value based at least in part on determining that the host system is authorized.

17. The apparatus of claim 16, wherein the region comprises a protected region associated with the cryptographic signature of the command.

18. The apparatus of claim 15, wherein, to generate the key pair, the controller is configured to cause the apparatus to:
generate a public key of the key pair based at least in part on a private key of the key pair, wherein the private key of the key pair corresponds to the cryptographic value.

19. The apparatus of claim 15, wherein the key pair comprises an asymmetric key pair.

20. A non-transitory computer-readable medium storing code comprising instructions which, when executed by a processor of an electronic device, cause the electronic device to:
receive, at a memory system, a command comprising an indication of a protected region of the memory system;
determine whether a host system is authorized to access the protected region based at least in part on a cryptographic signature of the command;
calculate a cryptographic value associated with data stored in a portion of the protected region based at least in part on determining that the host system is authorized to access the protected region; and
output the cryptographic value.
